(19) United States
(12) Patent Application Publication
(10) Pub. No.: US 2013/0050930 A1
(43) Pub. Date: Feb. 28, 2013

(54) HARD DISK BACKBOARD AND STORAGE SYSTEM

(71) Applicants: KANG WU, Shenzhen City (CN); BO TIAN, Shenzhen City (CN)

(72) Inventors: KANG WU, Shenzhen City (CN); BO TIAN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/457,555

(22) Filed: Apr. 27, 2012

(30) Foreign Application Priority Data
Aug. 31, 2011 (CN) 201110254964.5

(51) Int. Cl. G06F 1/16

(52) U.S. Cl. 361/679.33

(57) ABSTRACT

A hard disk backboard for connecting a plurality of hard disk drives to a first processor and a second processor includes a plurality of hard disk connectors, a multiplexer and a controlling unit. The multiplexer includes at least one group of first connecting pins connecting to a part of the connectors, at least one group of second connecting pins configured to be connected to the first processor, at least one group of third connecting pins configured to be connected to the second processor. The controlling unit controls the at least one group of first connecting pins to alternatively connect to the at least one group of second connecting pins or to the at least one group of third connecting pins.

### BACKGROUND

1. Technical Field

The exemplary disclosure generally relates to hard disk backboard and hard disk storage system, particularly to a hard disk backboard connecting to a plurality of processors and a hard disk storage system having a plurality of processors.

2. Description of Related Art

A 2U 4-in-1 server system includes four independent servers mounted on a hard disk backboard in a 2U chassis, where each server has a processor. Generally, 1U refers to the height of a standard lamination of 1.75 inches (about 4.445 cm), which is about the height of a hard disc drive. Each server is capable of supporting and controlling three hard disk drives. The hard disk backboard includes twelve hard disk connectors mounted on the hard disk backboard, so that the server system can communicate with twelve hard disk drives at the maximum capacity of the hard disk connectors of the hard disk backboard.

However, in use, users maybe use only two of the four servers, this will cause the hard disks connected to the inactive two servers to be unused.

Therefore, there is room for improvement within the art.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the disclosure.

FIG. 1 shows a block diagram of an exemplary embodiment of a hard disk storage system having a hard disk backboard.

FIG. 2 and FIG. 3 are schematic circuit diagrams of an exemplary embodiment of the storage system of FIG. 1.

### DETAILED DESCRIPTION

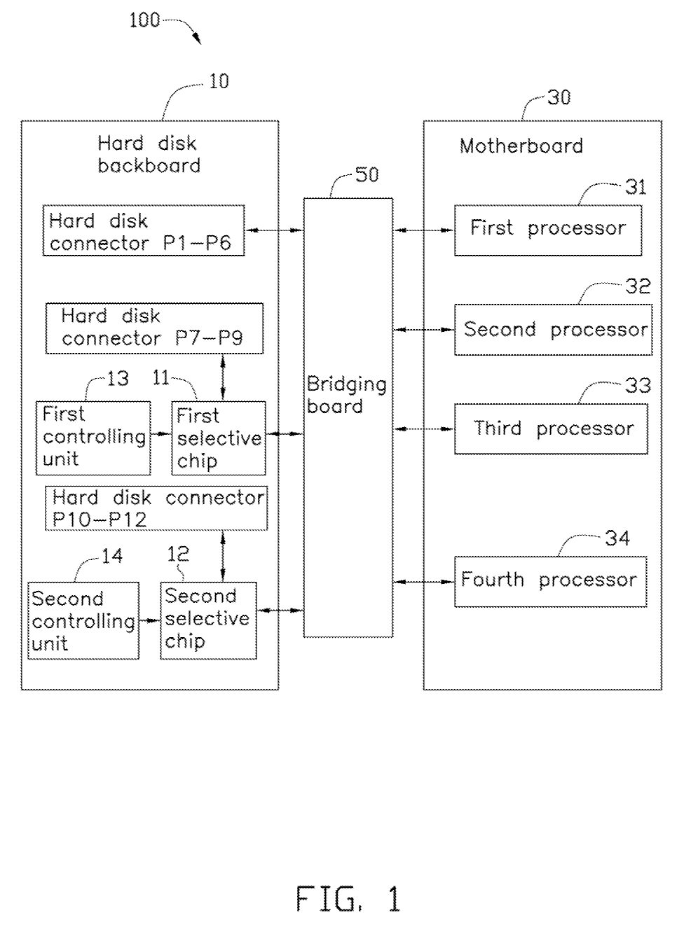

Referring to FIG. 1, an exemplary embodiment of a storage system 100 of a 2U 4-in-1 type includes a hard disk backboard 10, a motherboard 30 and a bridging board 50 connecting the backboard 10 to the motherboard 30. The backboard 10 includes a plurality of hard disk connectors P1-P12, a first multiplexer 11, a second multiplexer 12, a first controlling unit 13 and a second controlling unit 14. The motherboard 30 is capable of mounting four processors, e.g., a first processor 31 of a first server (not shown), a second processor 32 of a second server (not shown), a third processor 33 of a third server (not shown) and a fourth processor 34 of fourth server (not shown), thereon. Each of the first, second, third and the fourth processors 31, 32, 33 and 34 can be a single core processor, a dual core processor, or a quad core processor.

The hard disk connectors P1-P12 are used for plugging in hard disk drives (not shown). Each hard disk connector includes a forward differential signal transmitting (T+) pin, a reverse differential signal transmitting (T−) pin, a forward differential signal receiving (R+) pin and a forward differential signal receiving (R−) pin.

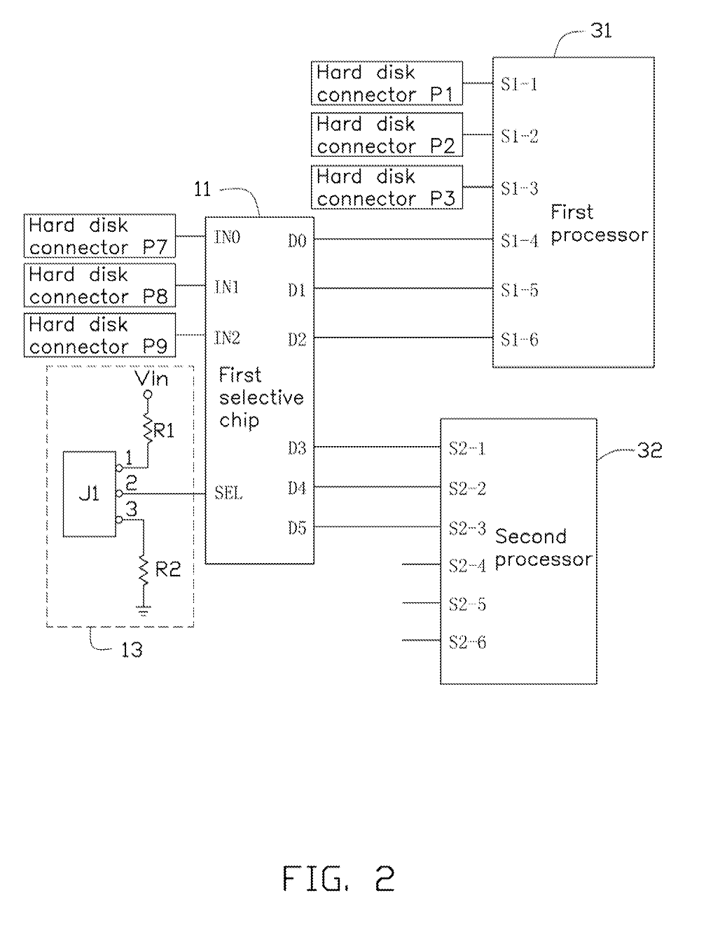

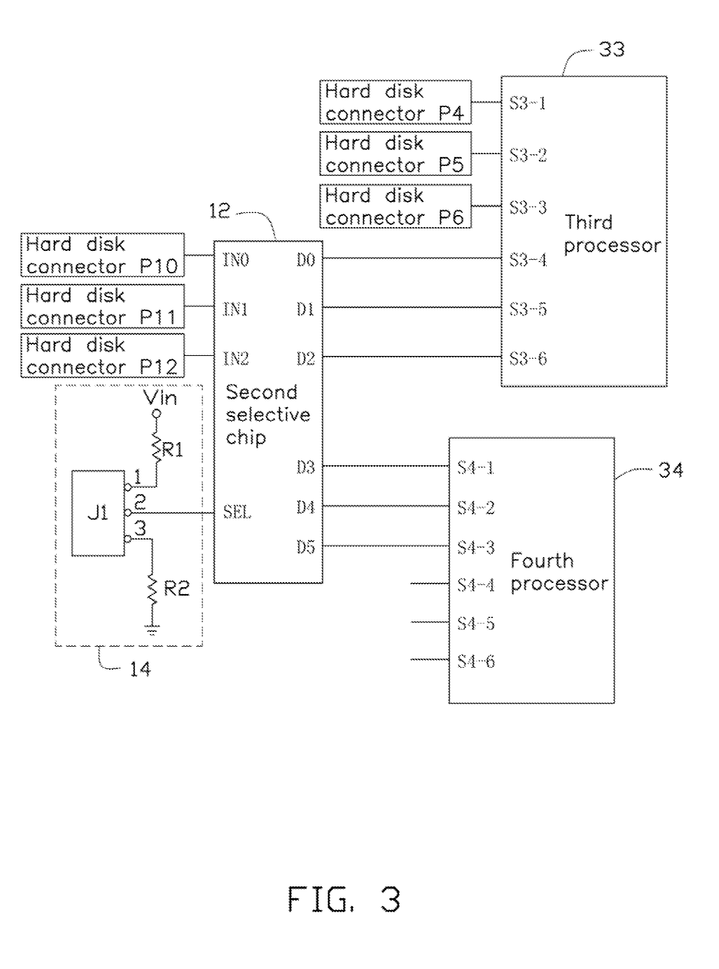

Referring to FIGS. 2 and 3, the first processor 31 includes six groups of differential signal pins, that is, differential signal pins S1-1˜S1-6. The second processor 32 includes six groups of differential signal pins, that is, differential signal pins S2-1˜S2-6. The third processor 33 includes six groups of differential signal pins, that is, differential signal pins S3-1˜S3-6. The fourth processor 34 includes six groups of differential signal pins, that is, differential signal pins S4-4˜S4-6. Each group of the differential signal pins include a T+ pin, a T− pin, a R+ pin and a R− pin. The differential signal pins S1-1˜S1-3 of the first processor 31 are connected to a first part of the connectors P1-P12, that is, the connectors P1-P3 of the backboard 10 via the bridging board 50 (shown in FIG. 1). The differential signal pins S3-1˜S3-3 of the third processor 33 are connected to the connectors P4˜P6 of the backboard 10 via the bridging board 50 (shown in FIG. 1).

The first multiplexer 11 includes three groups of first connecting pins IN0˜IN2, three groups of second connecting pins D0˜D2, three groups of third connecting pins D3˜D5, and a controlling pin SEL. Each group of the first, second and third connecting pins include a T+ pin, a T− pin, a R+ pin and a R− pin. The first connecting pins IN0˜IN2 are electronically connected to a second part of the connectors, that is, the connectors P7˜P9 of the backboard 10 respectively. The second connecting pins D0˜D2 are electronically connected to the differential signal pins S1-4˜S1-6 of the first processor 31 respectively. The third connecting pins D3˜D5 are electronically connected to the differential signal pins S2-1˜S2-3 of the second processor 32 respectively. The controlling pin SEL is electronically connected to the controlling unit 13. In the exemplary embodiment, the first multiplexer 11 is electronically connected to connectors P7˜P9 of the backboard 10 via differential signal lines (not shown) routed on the backboard 10, and is electronically connected to the first processor 31 and the second processor 32 via the bridging board 50 (shown in FIG. 1).

The first controlling unit 13 controls the first connecting pins IN0˜IN2 of the first multiplexer 11 to be alternatively connected either to the second connecting pins D0˜D2 respectively or to the third connecting pins D3˜D5 respectively, thereby the connectors P7-P9 will be connected either to the first processor 31 or to the second processor 32 under the control of the first controlling unit 13.

The first controlling unit 13 changes the voltage of the controlling pin SEL to control the connecting state of the first multiplexer 11. For example, when the first controlling unit 13 transmits a high level voltage signal (e.g. logical 1) to the controlling pin SEL, the first multiplexer 11 connects the first connecting pins IN0˜IN2 to the second connecting pins D0˜D2, thus the connectors P7˜P9 of the first backboard 10 are electronically connected to the differential signal pins S1-4˜S1-6 of the first processor 31 via the first multiplexer 11. When the first controlling unit 13 transmits a low voltage level signal (e.g. logical 0) to the controlling pin SEL, the first multiplexer 11 connects the first connecting pins INO˜IN2 to the third connecting pins D3˜D5, thus the connectors P7˜P9 of the first backboard 10 are electronically connected to the differential signal pins S2-4˜S2-6 of the second processor 32 via the first multiplexer 11.

In the exemplary embodiment, the first controlling unit 13 includes a jumper J1, a first resistor R1 and a second resistor R2. The jumper J1 includes a first pin 1 electronically connected to a power supply Vin via the first resistor R1, a second pin 2 electronically connected to the controlling pin SEL, and a third pin 3 grounded via the second resistor R2. When the jumper J1 connects the second pin 2 to the first pin 1, the controlling pin SEL is powered by the power supply Vin, and outputs a high level voltage signal. When the jumper J1 connects the second pin 2 to the third pin 3, the controlling pin SEL is grounded and outputs a low level voltage signal.

The first controlling unit 13 can be a programmable controller which generates and transmits a high level voltage signal or a low level voltage signal to the controlling pin SEL to control the first multiplexer 13 to connect the first connecting pins INO˜IN2 thereof either to the second connecting pins D0˜D2 or to the third connecting pins D3˜D5.

The second multiplexer 12 has a function and structure similar to that of the first multiplexer 11, and the second controlling unit 14 has a function and structure similar to that of the first controlling unit 13. The second controlling unit 14 controls the second multiplexer 12 to alternatively connect the connectors P10˜P12 either to the differential signal pins S3-3˜S3-6 of the third processor 33 or to the differential signal pins S4-1˜S4-3 of the fourth processor 34.

The first multiplexer 11 may alternatively connect the connectors P7˜P9 to the first processor 31 or to the second processor 32, and the second multiplexer 12 may alternatively connect the connectors P10˜P12 to the third processor 33 or to the fourth processor 34. Provided that the storage system 100 only includes two processors, e.g. the first processor 31 and the third processor 33, the first and second controlling units 13, 14 can be operated to control the first and second multiplexer 11, 13 to connect the connectors P7-P9 and P10-P12 to the first processor 31 and to the third processor 33 respectively. Therefore, first processor 31 can communicate with six hard disk drives connecting to the connectors P1˜P3, P7-P9, and the third processor 33 can communicate with six hard disk drives connecting to the connectors P4-P6, P10-P12. Provided that the storage system 100 includes four processors, e.g. the first, second, third and the fourth processors 31, 32, 33 and 34, the first and second controlling units 13, 14 can be operated to control the first and second multiplexer 11, 13 to connect the connectors P7-P9, P10-P12 with the second processor 32 and the fourth processor 34 respectively. Hence, each processor can communicate with three hard disk drives via the connectors. Therefore, the storage system 100 enables full use to be made of the connectors of the backboard 10.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A hard disk backboard, configured for connecting a plurality of hard disk drives to a first processor and a second processor, comprising:
a plurality of hard disk connectors each configured for connecting to a corresponding hard disk drive, and a first part of the connectors electronically connected to the first processor;
a multiplexer comprising at least one group of first connecting pins connecting to a second part of the connectors, at least one group of second connecting pins configured to be connected to the first processor, at least one group of third connecting pins configured to be connected to the second processor, and a controlling pin; and
a controlling unit electronically connecting to the controlling pin, the controlling unit controlling the at least one group of first connecting pins to be alternatively connect to the at least one group of second connecting pins respectively or to the at least one group of third connecting pins respectively.

2. The hard disk backboard as claimed in claim 2, wherein each group of the first connecting pins comprising at least one first connecting pin, each group of the second and third connecting pin respectively equal in number to the number of the first connecting pin, each group of the first connecting pins connected to one of the plurality of hard disk connectors correspondingly.

3. The hard disk backboard as claimed in claim 2, wherein each group of the first, second and third connecting pins are respectively comprise a forward differential signal transmitting pin, a reverse differential signal transmitting pin, a forward differential signal receiving pin and a forward differential signal receiving pin.

4. The hard disk backboard as claimed in claim 1, wherein the controlling unit controls the first connecting pins connected to the second connecting pins respectively or to the third connecting pins respectively by controlling voltage of the controlling pin.

5. The hard disk backboard as claimed in claim 4, wherein the controlling unit comprises a jumper, a first resistor and a second resistor, the jumper comprise a first pin electronically connected to a power supply via the resistor, a second pin electronically connected to the controlling pin, and a third pin grounded via the second resistor, when the jumper connects the second pin to the first pin, the controlling pin is powered by the power supply, and outputs a high level voltage, when the jumper connects the second pin to the third pin, the controlling pin is grounded and outputs a low level voltage.

6. A storage system, comprising:
a motherboard including a first processor and a second processor mounted on the motherboard; and
a hard disk backboard configured for connecting a plurality of hard disk drives to the first processor and the second processor, comprising:
a plurality of hard disk connectors each configured for connecting to a corresponding hard disk drive, and a first part of the connectors directly connected to the first processor;
a multiplexer comprising at least one group of first connecting pins connecting to a second part of the connectors, at least one group of second connecting pins configured to be connected to the first processor, at least one group of third connecting pins configured to be connected to the second processor, and a controlling pin; and
a controlling unit electronically connecting to the controlling pin, the controlling unit controlling the at least one group of first connecting pins to be alternatively connect to the at least one group of second connecting pins respectively or to the at least one group of third connecting pins respectively.

7. The storage system as claimed in claim 6, wherein each group of the first connecting pins comprising at least one first connecting pin, each group of the second and third connecting pin respectively equal in number to the number of the first connecting pin, each group of the first connecting pins connected to one of the plurality of unconnected hard disk connectors correspondingly.

8. The storage system as claimed in claim 7, wherein each group of the first, second and third connecting pins are respectively comprise a forward differential signal transmitting pin, a reverse differential signal transmitting pin, a forward differential signal receiving pin and a forward differential signal receiving pin.

9. The storage system as claimed in claim 6, wherein the controlling unit controls the first connecting pins connected to the second connecting pins respectively or to the third connecting pins respectively by controlling voltage of the controlling pin.

10. The storage system as claimed in claim 9, wherein the controlling unit comprises a jumper, a first resistor and a second resistor, the jumper comprise a first pin electronically connected to a power supply via the resistor, a second pin electronically connected to the controlling pin, and a third pin grounded via the second resistor, when the jumper connects the second pin to the first pin, the controlling pin is powered by the power supply, and outputs a high level voltage, when the jumper connects the second pin to the third pin, the controlling pin is grounded and outputs a low level voltage.

11. The storage system as claimed in claim 6, further comprising a bridging board electronically connected to the multiplexer, wherein the multiplexer is mounted on the hard disk backboard and is electronically connected to the first processor and the second processor via the bridging board.
